(19) United States
(12) Patent Application Publication
(10) Pub. No.: US 2007/0160355 A1
(43) Pub. Date: Jul. 12, 2007

(54) Image pick up device and image pick up method

(75) Inventors: Yoshimitsu Sasaki, Kyoto (JP); Kunihiro Imamura, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/597,797

(22) PCT Filed: Feb. 21, 2005
(86) PCT No.: PCT/JP05/02714

§ 371 Date: Aug. 8, 2006

(30) Foreign Application Priority Data
Feb. 25, 2004 (JP) 2004/049574

(51) Int. Cl. G03B 17/00

(52) U.S. Cl. 396/55; 348/208.4

(57) ABSTRACT

An imaging device of the present invention includes a MOS image acceptance sensor (12) including a light receiving surface made up of a plurality of pixel portions arrayed in a plurality of lines, a calculation unit (17) of detecting a horizontal shift amount and a vertical shift amount of an image on the light receiving surface at every horizontal cycle of line readout, a horizontal driving unit (13) of determining a head position to be a head pixel of a line at every line depending on the detected horizontal shift amount and a compensation unit (10) of performing horizontal compensation based on the determined pixel position and vertical compensation.

### TECHNICAL FIELD

The present invention relates to an imaging device using a solid-state image sensor, and particularly to image compensation for image blur due to hand jiggling movement in the imaging device.

### BACKGROUND ART

Conventionally, a video camera, a monitoring camera, an industrial camera and so on are known as imaging devices. Additionally, a mobile phone, a Personal Digital Assistant (PDA) and so on have become popular in recent years, and a strong market demand to add an imaging function for capturing an image to such small-sized mobile equipment has been increasing.

As a usage style of such small-sized mobile equipment, it is more likely that a user carries the handheld small-sized mobile equipment and takes an image by the handheld small-sized mobile equipment. In such cases, image blur due to hand jiggling movement is recognized as a problem. Image blur due to hand jiggling movement means that the imaging is moved up/down/left/right directions, which occurs while a user takes an image by the small-sized mobile equipment holding by hand, as the user's hand moves jerkily. An image compensation for such image blur due to hand jiggling movement is now significant to the small-sized mobile equipment.

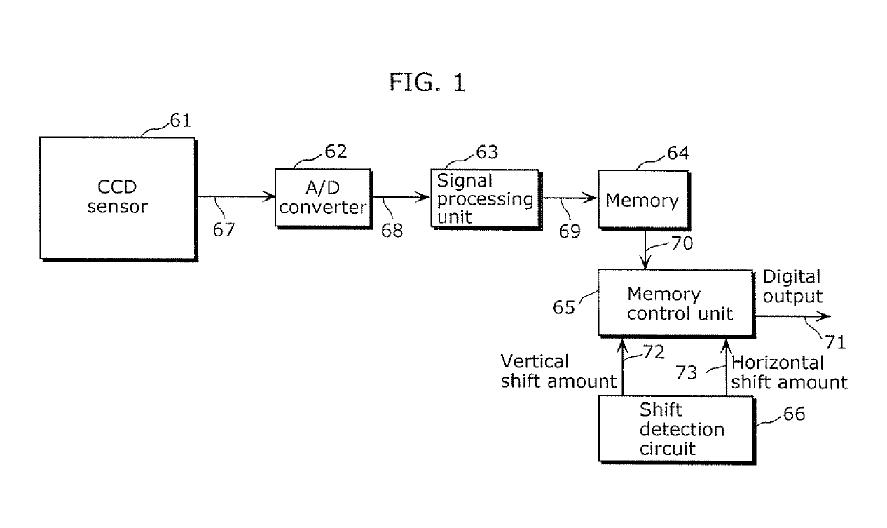

FIG. 1 shows a configuration of a case where an image compensation for hand jiggling movement is performed in an imaging device using a charged-coupled device (CCD) sensor as an image sensor.

The imaging device includes: a CCD sensor 61 having pixels of the number greater than the number of pixels for an image; an A/D converter 62 for converting an analog signal 67 from the CCD sensor 61 into a digital signal 68; a signal processing unit 63 for generating a YUV output out of the digital signal 68; a memory 64 for storing the YUV output 68; and a memory controller 65. The memory controller 65 obtains a horizontal shift amount 73 and a vertical shift amount 72 out of a shift detection circuit 66 as input, reads out the YUV output 70 stored in the memory 64, and outputs as a digital output 71.

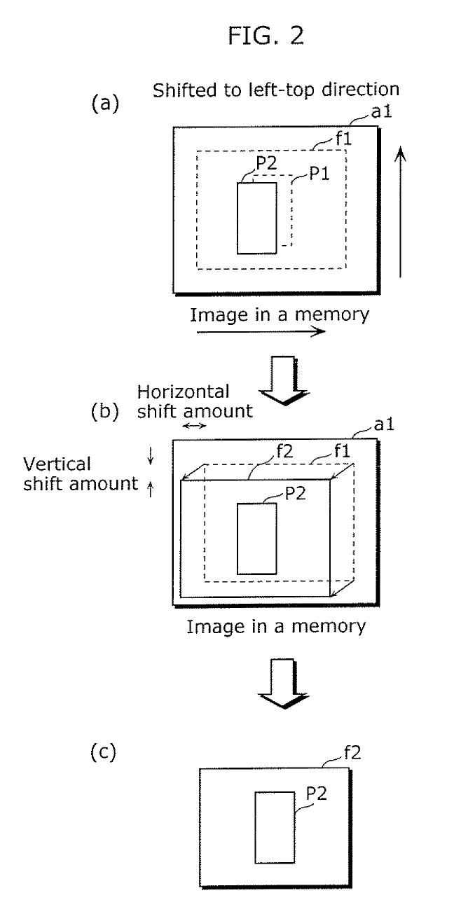

The analog signal 67, which has been read out of the CCD sensor 61, is converted into a digital signal 68 by the A/D converter 62. The signal processing unit 63 generates a YUV output 69 out of the digital signal 68, and describes a captured image in the memory 64. Next the memory controller 65 outputs an image of the number of pixels to be outputted by cropping out of the image stored in the memory 64, and then the cropped out image is outputted as the digital output 71. The imaging device performs this iteration in capturing images. In a case where a sensor is shifted due to hand jiggling movement and the like, an image shifted to horizontal direction and vertical direction comparing with the previous frame image is captured as a result, and it is called as image blur due to hand jiggling movement. The compensation of this case is shown in FIG. 2. The shift detection circuit 66 detects the horizontal shift amount 73 and the vertical shift amount 72 in a frame cycle. In FIG. 2, a subject P1 in a previous outputted image frame f1 in an imaging size al is shifted to a position of a subject P2 of the sequent imaging. In this case, the memory controller 71 sets up a position, which is shifted from the previous frame f1 by the horizontal shift amount, as a starting position for the horizontal readout of an outputted image f2. Concurrently the memory controller 71 sets up a position, which is shifted from the previous frame f1 by the vertical shift amount, as a starting position for vertical readout. The image compensation for image blur due to hand jiggling movement is realized by reading out the outputted image f2 starting from these positions.

Such compensation is possible, since a shutter is released every vertical cycle for the CCD sensor. In fact, there is no time difference for the accumulated time and the readout cycle between the pixels for the entire pixels in one frame, so that an image distortion in one frame is not recognizable. The compensation for shifting of images between frames, that is to say, the image compensation for image blur due to hand jiggling movement between frames is possible.

In addition to such compensations, an optical compensation method is also suggested. While the horizontal shift amount and the vertical shift amount from the movement detection circuit are monitored every frame cycle, the lens is moved based on the shift distance. The compensation for image blur due to hand jiggling movement is, therefore, realized by fixing the position of an imaging in a sensor (for example the patented reference 1).

Though such image compensation for image blur due to hand jiggling movement is realized, there is a problem in introducing the CCD sensor to a small-sized mobile equipment. The power of the CCD sensor is multi-power driving, in other words plural number of positive and negative powers such as +15V, +9V and −9V are required. On the contrary, the MOS image sensor can be single driving of 2.8V, so that low power consumption can be realized. Additionally since the power structure can be uncomplicated comparing with the CCD sensor, so that the number of electric circuits can be less. And thus the MOS image sensor is suitable for the small-sized mobile equipment. Accordingly the MOS sensor is more and more chosen as a sensor to be built in the small-sized mobile equipment.
(Patented Reference 1: Japanese-laid open patent application no. 2000-147586)

### DISCLOSURE OF INVENTION

Problems that Invention is to Solve

However according to a conventional compensation technology for image blur due to hand jiggling movement, there exists a problem that an image distortion in one frame arisen unexpectedly for the MOS image sensor can not be compensated.

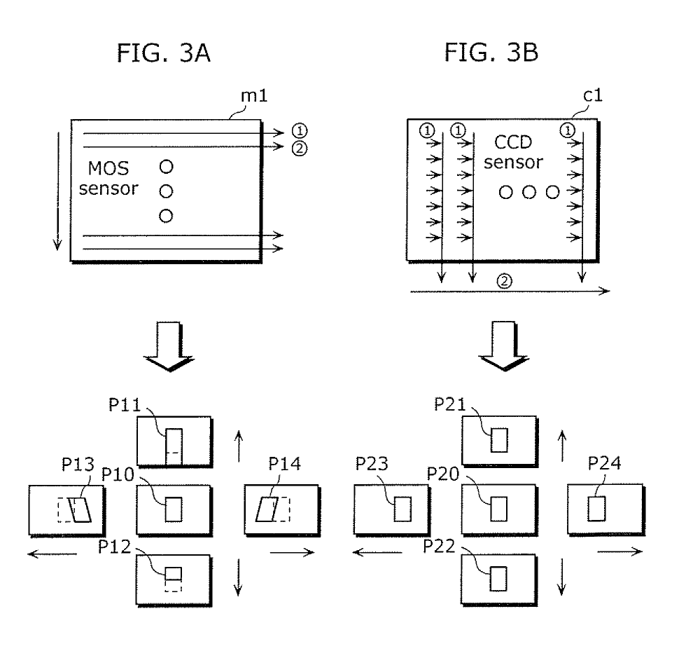

The difference between the shutter of the MOS image sensor and the shutter of the CCD sensor is shown in FIG. 3A and FIG. 3B. For the MOS image sensor, the shutter is released at each line as shown in FIG. 3A, and then readout is performed at each line sequentially. For the CCD sensor, the shutter is released all at once for the entire pixels, and thus readout is performed to vertical CCD as shown in FIG. 3B.

Accordingly the time difference is generated for each horizontal line for the MOS image sensor, so that an image is distorted in oblique direction in a case where the sensor is moved to horizontal direction (refer to subjects P13 and P14), and an image is distorted like expanded and contracted in top and bottom directions in a case where the sensor is moved to top and bottom directions (refer to subjects Pl1 and P12). However such distortions are not generated for the CCD sensor. Accordingly such distortions in the frame have not been compensated by the conventional image compensation for image blur due to hand jiggling movement.

In view of the above-mentioned problem, the object of the present invention is to provide an imaging device which compensates an image distortion in a frame generated by the MOS image sensor.

Means to Solve the Problems

In view of aforesaid problems, the imaging device according to the present invention includes: a MOS image sensor having a light receiving surface made up of a plurality of pixel units arrayed in a plurality of lines; a detection unit for detecting a horizontal shift amount in images corresponding to two or more lines from among images on the respective lines read out for each horizontal cycle from the MOS image sensor; a determination unit for determining a head position to be a head pixel in at least one line out of the plurality of lines, based on the horizontal shift amount; and a horizontal compensation unit for generating a compensation image based on the determined head position.

Here, the detection unit may detect the horizontal shift amount of the images corresponding to all adjacent two lines in the plurality of lines. The determination unit may determine the head position at least one of the two or more lines, based on the horizontal shift amount. In addition, the determination unit may determine the head position of the line read out subsequently, between the adjacent two lines of all adjacent two lines, based on the horizontal shift amount.

According to the above-mentioned configuration, image distortion generated in frame for the MOS image sensor particularly to a distortion in horizontal direction can be compensated.

Moreover the compensation can be realized with smaller size of the circuit and less number of parts for the compensation.

Here, the detection unit may include: an acceleration sensor for detecting an acceleration from a movement of the imaging device; and a calculation unit for calculating the horizontal shift amount based on the detected acceleration.

According to this configuration, the horizontal shift amount can be detected easily using the existing acceleration speed sensor and the like.

Here, the acceleration sensor may detect the acceleration for each horizontal cycle, and the calculation unit may calculate the horizontal shift amount in one horizontal cycle, and the horizontal compensation unit may include a read-out unit for reading pixel signals, whose number is corresponding to the number of horizontal pixels, out of said MOS image sensor starting from the head position determined by the determination unit.

According to this configuration, it is possible to read out, from the head position, the pixel signals whose number is corresponding to the number of horizontal pixels for the image starting, and possible to perform compensation in horizontal direction at the same time with the line read-out.

Here, the determination unit may determine the head position in units of a subpixel, and the horizontal compensation unit may further include a horizontal interpolation unit for compensating a pixel array in the line read out by the read-out unit to the subpixel by means of pixel interpolation.

According to this configuration, it is possible to perform the compensation in units of a subpixel, in addition to the compensation of the head position in units of a pixel pitch in horizontal direction.

Here, the imaging device may further include a storage unit for storing a frame image read out of said MOS image sensor, and the horizontal compensation unit may compensate the head position to the frame image stored in the storage unit.

According to the configuration, a frame image is stored in the storage unit once, and then the compensatin is performed, so that the existing MOS image sensor can be used.

Here, the detection unit may further detect a vertical shift amount of the image, and the imaging device may further include a vertical compensation unit for compensating a distortion expanded and contracted in vertical direction of an image captured in an image unit, based on the detected vertical shift amount.

According to the configuration, a distortion expanding and contracting in vertical direction can be compensated in addition to a distortion in horizontal direction in the frame.

Here, the vertical compensation unit may include: a line buffer for storing pixel signals, whose number is corresponding to a plurality of lines read out of said MOS image sensor, a determination unit for determining a compensation line position for each line, based on the vertical shift amount detected by the detection unit, and a vertical interpolation unit for calculating pixel signals at the position of a compensation line by means of pixel interpolation between lines using pixel signals stored in the line buffer and pixel signals read out from said MOS image sensor.

According to this configuration, it is not necessary to include a memory for storing images of one frame, but to include a line buffer for storing plural lines about three lines for operation, so that the compensation of the image distortion in horizontal direction and vertical direction in the frame can be implemented with smaller circuit area.

Here, the detection unit may detect a shift amount between two frames stored in the storage unit, and the horizontal compensation unit and the vertical shift unit may perform inter-frame compensation based on the shift amount.

According to this configuration, a horizontal shift amount including a shifting amount in horizontal direction and a vertical shift amount including a shifting amount in vertical direction are used, so that a shifting of inter-frame can be compensated at the same time with the intra-frame compensation.

Effects of the Invention

According to the imaging device of the present invention, an image distortion in a frame which is a defect of the MOS image sensor can be actually compensated with smaller circuit size and less number of parts.

Moreover, the imaging device, which is able to compensate an image distortion and compensate the distorted image by hand jiggling movement at the same time without adding number of parts, can be configured.

Further the compensation for an image distortion and for hand jiggling movement can be realized with the conventional MOS image sensor as well.

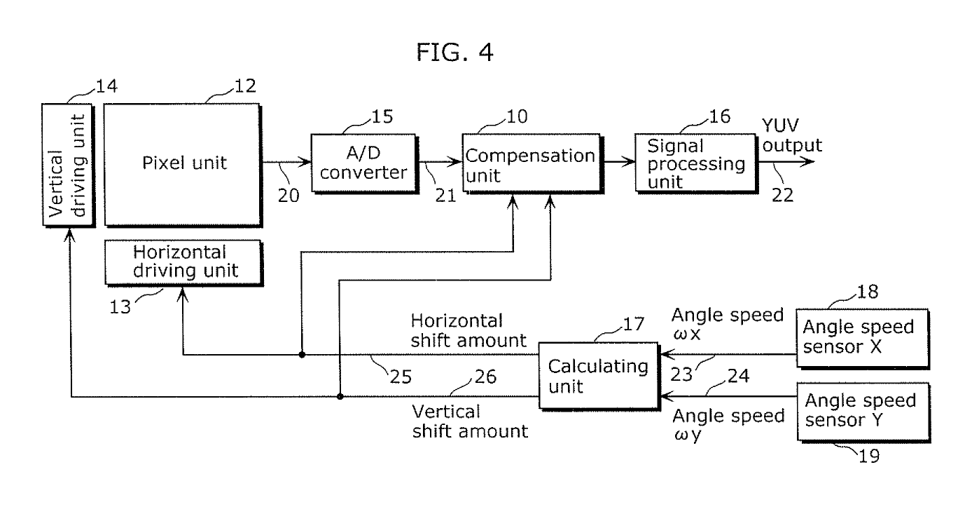

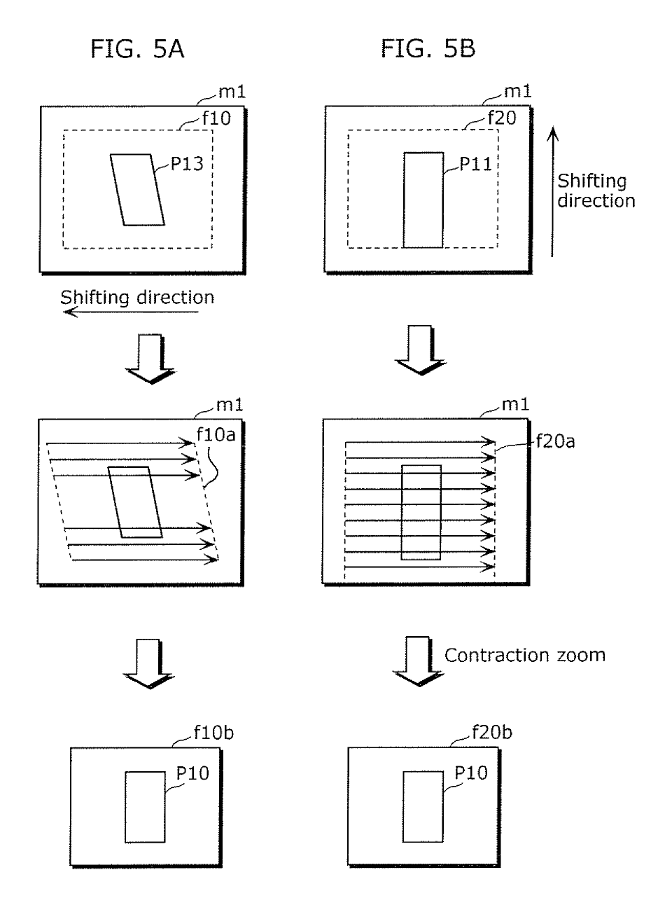

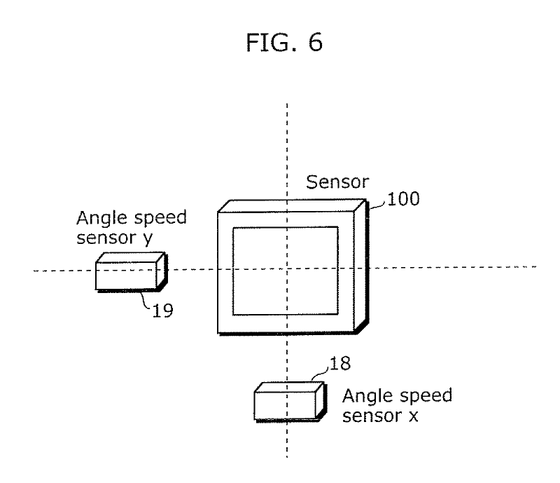

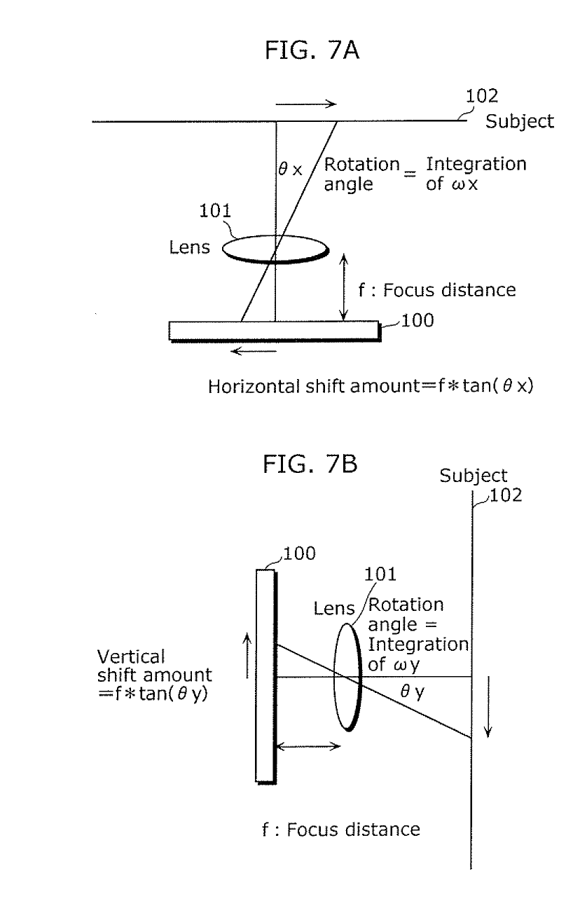

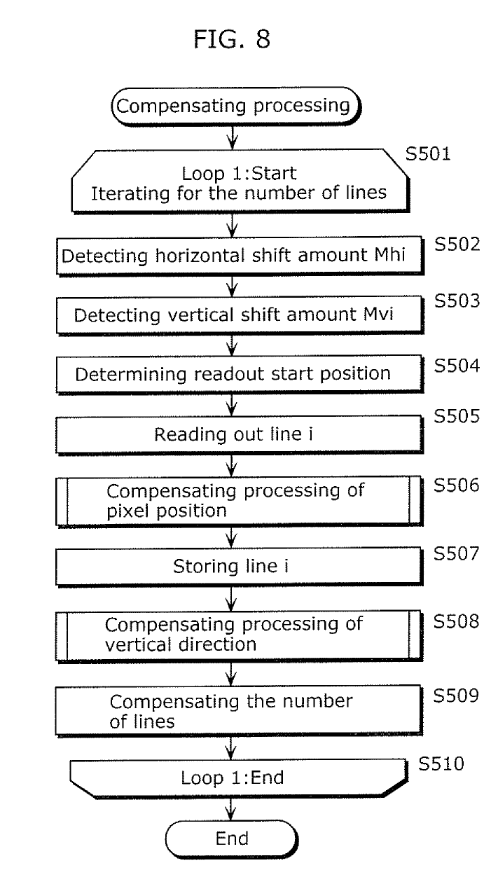

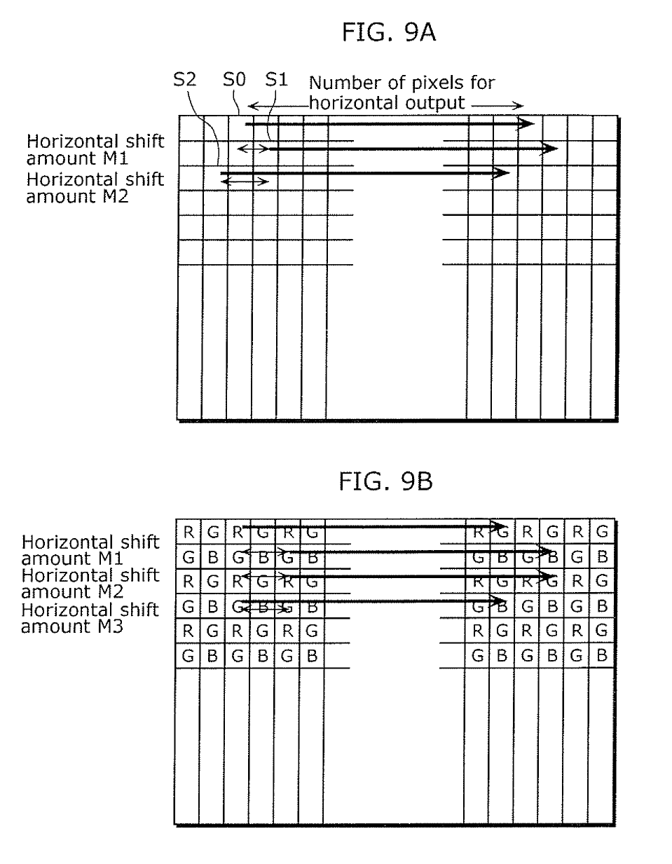

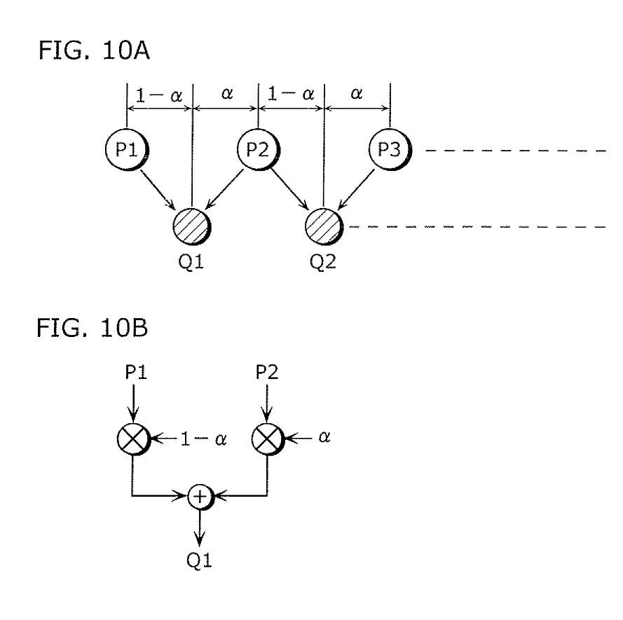

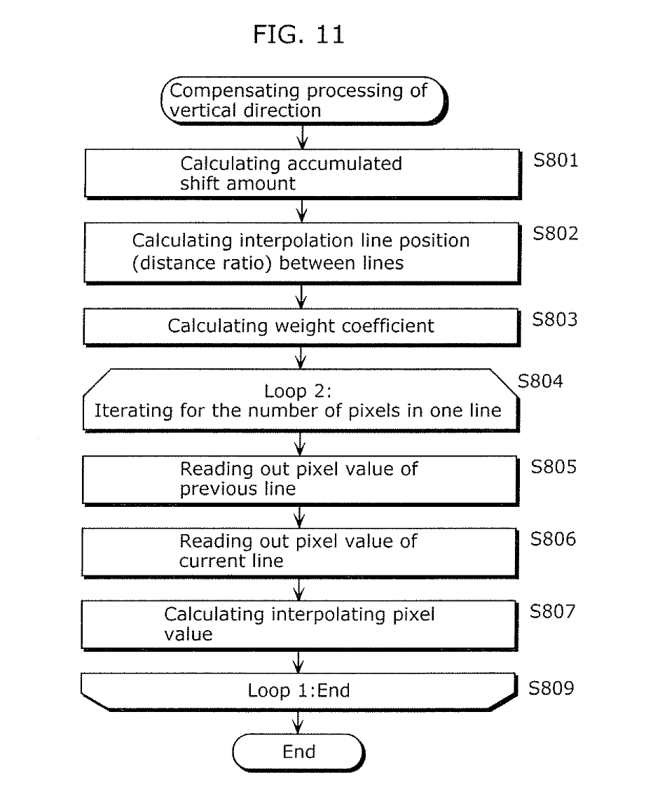

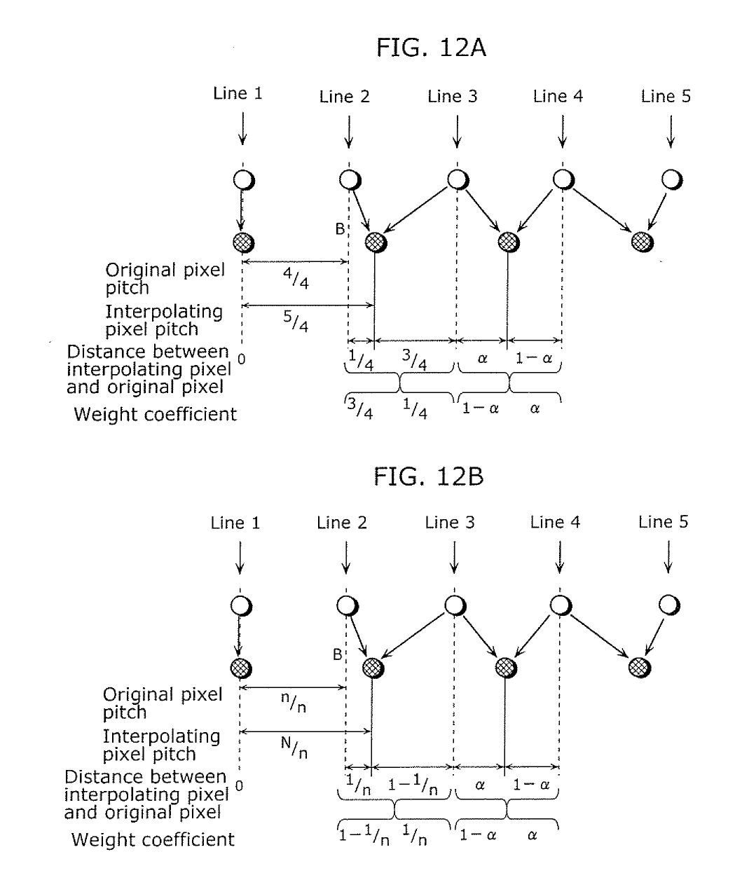

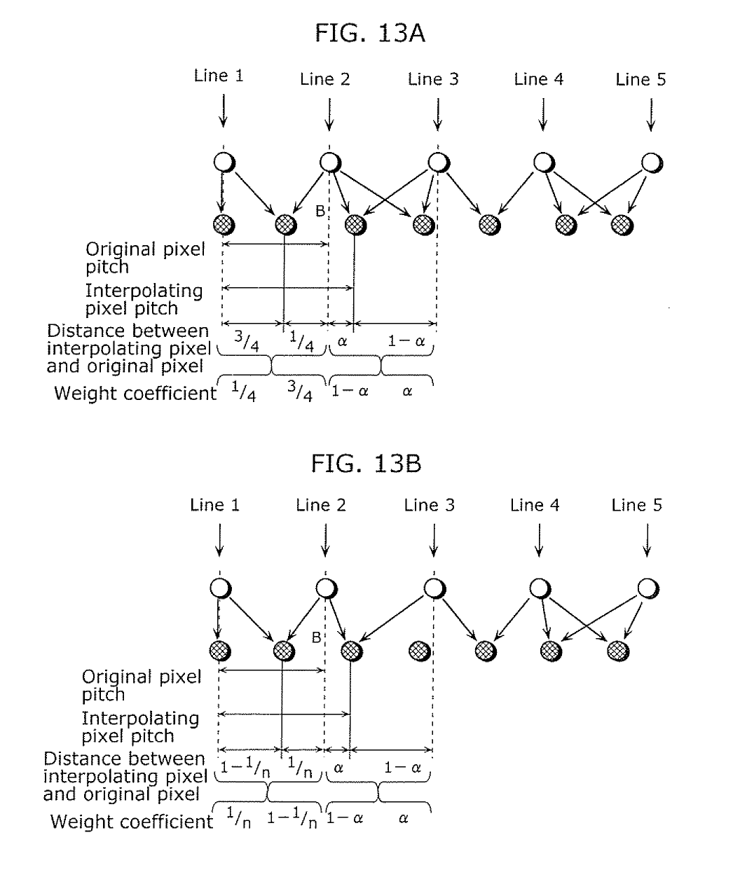

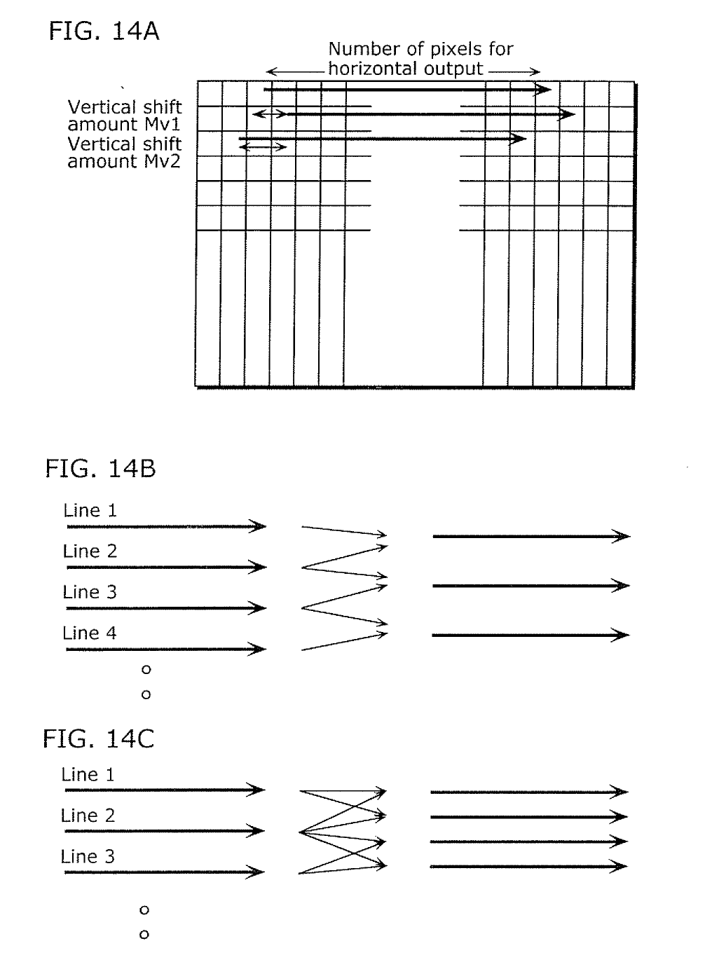

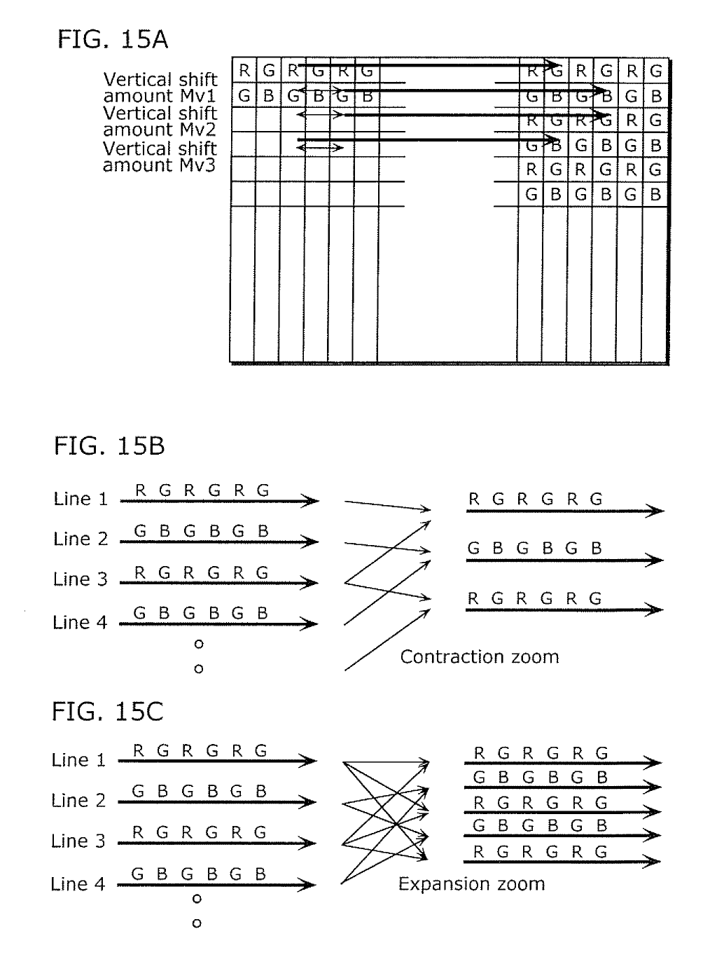

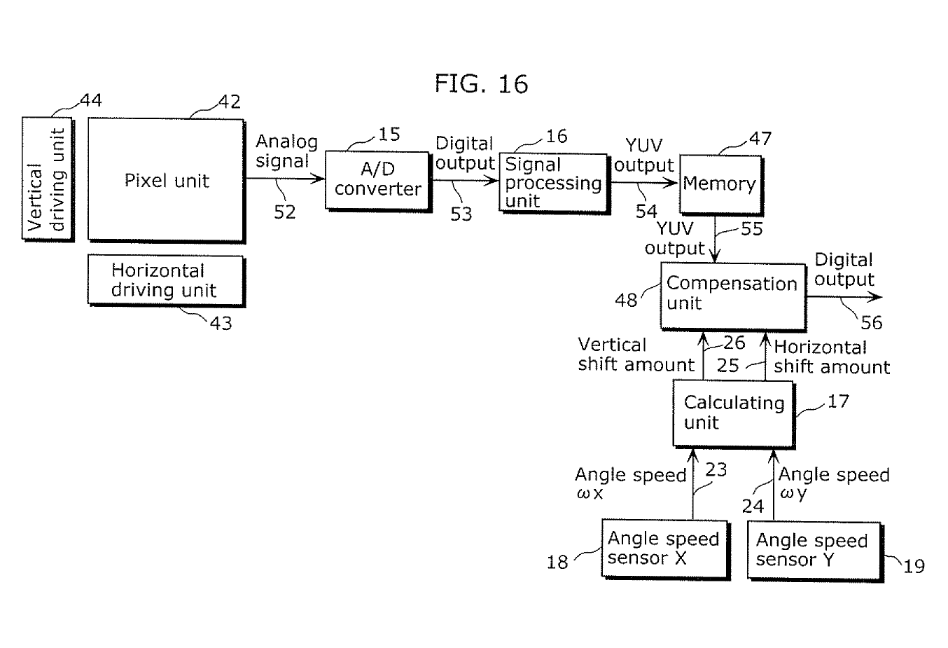

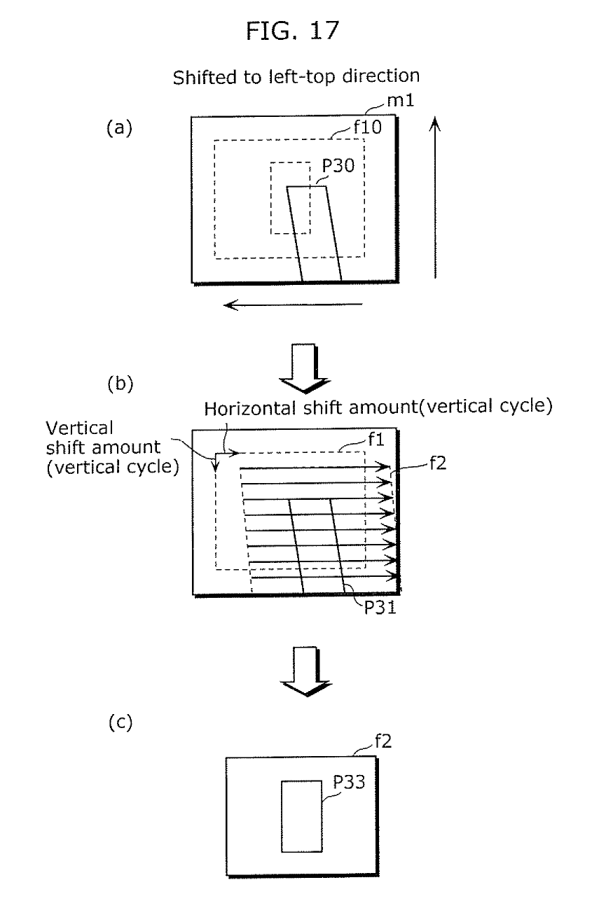

### BRIEF DESCRIPTION OF DRAWINGS

[FIG. 1] FIG. 1 shows a configuration of a case where image compensation for image blur due to hand jiggling movement is performed in an imaging device using a CCD sensor as an image sensor

[FIG. 2] FIG. 2 is a drawing to show a procedure of conventional image compensation for image blur due to hand jiggling movement.

[FIG. 3A] FIG. 3A is a drawing to show a shutter operation of a MOS image sensor.

[FIG. 3B] FIG. 3B is a drawing to show a shutter operation of a CCD sensor.

[FIG. 4] FIG. 4 is a block diagram to show a configuration of a MOS imaging device of the first embodiment of the present invention.

[FIG. 5A] FIG. 5A is a drawing to show horizontal compensation.

[FIG. 5B] FIG. 5B is a drawing to show vertical compensation.

[FIG. 6] FIG. 6 is a drawing to show a positional relation of a horizontal angle speed sensor, a vertical angle speed sensor and a light receiving surface.

[FIG. 7A] FIG. 7A is a drawing to show a calculation method for a horizontal shift amount.

[FIG. 7B] FIG. 7B is a drawing to show a calculation method for a vertical shift amount.

[FIG. 8] FIG. 8 is a flowchart to show a process of compensation for an image distortion in capturing image of one frame.

[FIG. 9A] FIG. 9A is a drawing to show a head position for pixels to be a head in a line.

[FIG. 9B] FIG. 9B is a drawing to show a head position for pixels to be a head in a line.

[FIG. 10A] FIG. 10A is a drawing to show pixel position compensation processing on a subpixel basis.

[FIG. 10B] FIG. 10B shows an example of a circuit for a linear compensation in a compensation unit.

[FIG. 11] FIG. 11 is a flowchart to show vertical compensation processing in detail.

[FIG. 12A] FIG. 12A is a drawing to show vertical compensation processing.

[FIG. 12B] FIG. 12B is a drawing to show vertical compensation processing.

[FIG. 13A] FIG. 13A is a drawing to show vertical compensation processing.

[FIG. 13B] FIG. 13B is a drawing to show vertical compensation processing.

[FIG. 14A] FIG. 14A is a drawing to show vertical compensation processing to a monochrome image.

[FIG. 14B] FIG. 14B is a drawing to show vertical compensation processing to a monochrome image.

[FIG. 14C] FIG. 14C is a drawing to show vertical compensation processing to a monochrome image.

[FIG. 15A] FIG. 15A is a drawing to show vertical compensation processing to a color image.

[FIG. 15B] FIG. 15B is a drawing to show vertical compensation processing to a color image.

[FIG. 15C] FIG. 15C is a drawing to show vertical compensation processing to a color image.

[FIG. 16] FIG. 16 is a block diagram to show a configuration of an imaging device of the second embodiment of the present invention.

[FIG. 17] FIG. 17 (a) to (c) is a drawing to show processing of intra-frame compensation and inter-frame compensation.

### NUMERICAL REFERENCES

10 Compensation unit
12 Light receiving surface
13 Horizontal driving unit
14 Vertical driving unit
15 A/D converter
16 Signal processing unit
17 Calculation unit
18 and 19 Angle speed sensor
42 Light receiving surface
43 Horizontal driving unit
44 Vertical driving unit
47 Memory
48 Compensation unit

### BEST MODE FOR CARRYING OUT THE INVENTION

### First Embodiment

<Configuration of an Imaging Device>

FIG. 4 is a block diagram to show a configuration of a MOS imaging device of the first embodiment of the present invention. This imaging device includes a compensation unit 10, a light receiving surface 12, a horizontal driving unit 13, a vertical driving unit 14, an A/D converter 15, a signal processing unit 16, a calculation unit 17, an angle speed sensor 18 and an angle speed sensor 19.

The compensation unit 10 performs compensation for an image distortion in horizontal direction and compensation for an image distortion in vertical direction. These compensations for the image distortions are described using FIG. 5A and FIG. 5B.

FIG. 5A is a drawing to show horizontal compensation. As shown in the uppermost drawing, a size of an image of a frame image f10 is smaller than an image area ml of the light receiving surface 12. A subject P13 is originally a rectangular. However the image of the subject P13 is distorted like tilted in horizontal direction due to a shift of the imaging device to left direction at the time of image capturing (refer to FIG. 3A). As shown in a frame image f10a in the middlemost drawing in FIG. 5A, the compensation unit 10 and the horizontal driving unit 13 make an adjustment of a is head position, which should be a head pixel in a line, for each line based on a horizontal shift amount so as to compensate an image distortion in horizontal direction, and then read out pixel signals in a horizontal line starting from the adjusted head positions. At this time, the horizontal driving unit 13 makes adjustment of the head positions on a pixel basis, further the compensation unit 10 makes adjustment of the head positions on a subpixel basis which is smaller than a pixel by means of inter-pixel interpolation. The image distortion in horizontal direction of a frame image f10b can be compensated as shown in the lowermost drawing in FIG. 5A as a result.

FIG. 5B is a drawing to show vertical compensation. As shown in the uppermost drawing in FIG. 5B, an image of a subject P11 is distorted by expanded in vertical direction due to a shift of the imaging device to top direction at the time of image capturing (refer to FIG. 3A). As shown in a frame image f20a in the middlemost drawing in FIG. 5B, the compensation unit 10 includes a line buffer to store pixel values of plural lines (for example about three lines), and compensates the line position in vertical direction using the frame image f20a, which is longer in length to bottom direction than the frame image f20, based on the vertical shift amount so as to compensate the image distortion in vertical direction. In fact the position of lines and the number of lines are compensated so as to make the number of lines be the same as the frame f20 by pixel interpolation of inter-line for the frame image f20a of the captured image. The image distortion in vertical direction can be compensated for a frame image f20b as shown in the lowermost drawing in FIG. 5B as a result.

The light receiving surface 12, the horizontal driving unit 13, and the vertical driving unit 14 configure the MOS image sensor.

The light receiving surface 12 has an image area ml as shown in FIG.

5A and FIG. 5B. The horizontal driving unit 13 reads pixel signals is as many as the number of pixels in the horizontal line out of the lines in the frame image f10a or the frame image f20a at the same time, and then outputs each pixel signal as an analog signal 20 sequentially. At this time, the horizontal driving unit 13 makes adjustment of the readout head position in each line on a pixel basis based on the horizontal shift amount outputted from the calculation unit 17. The vertical driving unit 14 selects the line of the frame image f10a or the frame image f20a one by one at every horizontal cycle. At this time the vertical driving unit 14 makes adjustment of the number of lines to be selected based on the horizontal shift amount outputted from the calculation unit 17.

The AID converter 15 converts the analog signal 20 which is compensated in horizontal direction by the horizontal driving unit 13 into a digital signal 21, and then outputs the digital signal 21 to the compensation unit 10.

The signal processing unit 16 generates a YUV outputting signal 22 from the digital signal 21 expressed in RGB.

The angle speed sensor 18 is placed in centerline in vertical direction of the light receiving surface 12 as shown in FIG. 6, and detects an angular acceleration in horizontal direction of the light receiving surface 12. The angle speed sensor 19 is placed in centerline in horizontal direction of the light receiving surface 12 as shown in FIG. 6, and detects an angular acceleration in vertical direction of the light receiving surface 12. An acceleration sensor can be substituted for the angular acceleration sensors 18 and 19 in the configuration.

The calculation unit 17 calculates the horizontal shift amount and the vertical shift amount at each horizontal cycle based on the angle speed outputted from the angle speed sensor 18 and the angle speed sensor 19.

FIG. 7A is a drawing to show a calculation method for a horizontal shift amount by the calculation unit 17. As shown in FIG. 7A, it is assumed that the light receiving surface 12 and a lens 101 are located at a distance of a focal length f of the lens 101 from each other. The calculation unit 17 calculates a rotation angle Θx by integrating the angular acceleration ωx detected by the angular acceleration sensor 18 for the duration of one horizontal cycle. Further the calculation unit 17 calculates f * tan(Θx), which is the horizontal shift amount for one horizontal cycle of an image of the light receiving surface 12. FIG. 7B is a drawing to show a calculation method for a vertical shift amount. The calculation unit 17 calculates f*tan(Θy), which is the vertical shift amount for one horizontal cycle like FIG. 7A.

<Compensation Processing>

FIG. 8 is a flowchart to show a process of compensation for image distortion in capturing an image of one frame. In the drawing, a loop 1 (S501 to S510) shows horizontal compensation and vertical compensation in readout of i-th of line (hereinafter called as line i). Firstly the calculation unit 17 detects the horizontal shift amount Mhi and the vertical shift amount Mvi in one horizontal cycle (5502 and S503). It should be noted that the horizontal shift amount and the vertical shift amount are 0 (zero) in the initial line (line 1) of the frame image. Additionally the horizontal shift amount Mhi and the vertical shift amount Mvi use a pixel pitch or a line pitch as the unit. In other words, in a case where the horizontal shift amount Mhi is 1.00, it is equivalent to a shift of one pixel pitch, and 0.75 is equivalent to a shift of ¾ pixel pitch. In a case where the vertical shift amount Mvi is 0.5, it is equivalent to a shift of ½ line pitch.

Next the horizontal driving unit 13 determines a readout start position (a head position) of line i based on the horizontal shift amount Mhi (S504).

A drawing to describe the head positions determined by the horizontal driving unit 13, in a case where the frame image is a monochrome image, is shown in FIG. 9A. The horizontal driving unit 13 determines a certain fixed position S0 as a head position of the initial horizontal line 1. The readout start position S1 of the horizontal line 2 is determined at a position shifted by the horizontal shift amount M1 from S0 (S1=S0+M1). Here M1 is the integer portion of the horizontal shift amount Mhl, and a shift to left direction is positive. Similarly the head positions S2, S3 . . . are determined for the number of lines to be outputted repeatedly. The above-mentioned readout method is called as a horizontal shift readout. Horizontal compensation of pixel unit (pixel pitch unit) is performed in the horizontal shift readout,

Additionally a drawing to describe the head positions determined by the horizontal driving unit 13, in a case where the frame image is a color image, is shown in FIG. 9B. In the case of a monochrome image, the minimum unit of a shift amount is one pixel. On the other hand, in the case of a color image, the minimum unit of a shift amount is two pixels (that is equivalent to one pixel of a YUV signal), since four pixels are required (horizontal two pixels and vertical two pixels in fact) at the time of generating a YUV signal in the latter stage. The case of RGB is exemplified in FIG. 9B, and the case of complementary color filter and other colors' filters are the same.

Subsequently the horizontal driving unit 13 reads the pixel signals as many as the number of pixels in a horizontal line in the frame image out of the line i starting from the determined head position (S505). The read-out pixel signals are stored in the line buffer in the compensation unit 10 through the A/D converter 5.

The compensation unit 10 performs compensation processing for a pixel position on a subpixel basis, which is smaller than the pixel pitch based on the fractional portion of the horizontal shift amount Mhi, to the pixel signals in one line (that is equivalent to one line of a frame image) stored in the line buffer (S506). FIG. 10A is a drawing to show a pixel position compensation processing on a subpixel basis. In FIG. 10A, the fractional portion of the horizontal shift amount Mhi is represented by a. The pixels P1, P2 . . . represent pixels stored in the line buffer. The pixels Qt, Q2 . . . represent the compensated pixels. In this case the compensation unit 10 determines the position of the pixel Q1 at the position where the distance ratio of pixels P1−Q1 to Q1−P2 is a to (1−a). Further the compensation unit 10 calculates the value of the pixel Q1 by linear interpolation for the pixels P1 and P2 using the inverse ratio of the distance ratio as a weight. In fact, it is calculated as the pixel Q1=(1−a)*P1+a*P2. The pixels Q2, Q3 . . . are calculated in the same way. FIG. 10B shows an example of a circuit for linear interpolation in the compensation unit 10. Accordingly the compensation unit 10 compensates the pixel position in horizontal direction on a subpixel basis. Each pixel value Qj (j is from 1 up to the number of horizontal pixels) in line i after compensation is stored in the line buffer.

After this step, the compensation unit 10 performs vertical compensation processing for compensating the image distorted in expanded and contracted in vertical direction (S508). More particularly the compensation unit 10 calculates the pixel signals in a line position based on the vertical shift amount Mvi by pixel interpolation between lines using the pixel signal QJ of a line (i−1) or a line (i+1) stored in the line buffer, and the pixel signal QJ of the line i.

FIG. 12A is a drawing to show vertical compensation processing. In FIG. 12A, the right-left direction in the drawing corresponds to vertical direction of the image, the white-color circles denote head pixels Q1 (called as original pixel) of lines 1, 2, . . . , while the shaded circles denote pixels after compensation in a line position after vertical compensation (called as interpolation pixel). In the drawing, it is shown that in a case where Mvl is −0.25 (in a case where a vertical shift is 1/4pixel toward the bottom during the time after readout of line 1 till the start of readout of line 2). In this case, the line pitch between the original pixel line 1 and the original pixel line 2 is 1, while the line pitch between the line 1 and the line 2 after compensation is 5/4. In this case, the compensation unit 10 judges that the line position of the line 2 to be interpolated is between the line 2 and the line 3 of the original pixels, and the distance ratio is 1/4 to 3/4. Further the compensation unit 10 calculates each pixel value of the interpolation line 2 by linear interpolation of corresponding pixels between the original pixel line 2 and the original pixel line 3 using the inverse ratio of the distance ratio as weight coefficients. As shown in FIG. 12A, the weight coefficients of this case are 3/4 and 1/4. Accordingly in a case where the imaging device shifts in bottom direction, the image is expanded so as to compensate the image distortion contracted in vertical direction. Further FIG. 12B is a drawing to show a case where Mv1 is −1/n. In this case the weight coefficients used for linear compensation between the original pixel line 2 and the original pixel line 3 are 1/n and (1−1/n).

In FIG. 13A, it is shown that Mv1 is +0.25 (in a case where a vertical shift is 1/4 pixel in top direction during the time after readout of the line 1 till the start of readout of the line 2). A different point from FIG. 12A is that linear interpolation is performed between the original pixel line 1 and the original pixel line 2 in FIG. 13A. In a case where the imaging device shifts in top direction, the image is contracted so as to compensate the image distortion expanded in vertical direction as a result, In FIG. 13B, it is shown that Mv1 is+1/n. In this case, the weight coefficients are 1/n and (1−1/n).

Lastly the compensation unit 10 and the vertical driving unit 14 compensate the number of iterations of the loop 1. For example in a case where the number of the interpolation lines is increased by one comparing to the number of the original pixel lines, the number of the loop iterations is decreased by one. On the other hand in a case where the number of the interpolation lines is decreased by one comparing to the number of the original pixel lines, the number of the loop iterations is increased by one, and when the read-out line reaches to the last line, the loop 1 terminates. Accordingly the compensation unit 10 iterates horizontal line readout processing until the number of the interpolated lines reaches to the number of vertical lines required for a frame image, or until readout of the horizontal line reaches to the last line of the image capturing area.

<Vertical Compensation Processing>

FIG. 11 is a flowchart to show vertical compensation processing in detail. As shown in the drawing, firstly the compensation unit 10 calculates an accumulated vertical shift amount up to a line 1 from Mvi inputted from the calculation unit 17 (S801), the distance ratio between lines of a position of an interpolation line and original pixels of an interpolation line, and calculates weight coefficients using an inverse ratio of a distance ratio (S803). For example, in the case of FIG. 12A, the position of the interpolation line 2 is 5/4, the distance ratio is 3/4to 1/4and the weight coefficients are 1/4and 3/4. In the case of FIG. 13A, the position of the interpolation line 2 is 3/4, the distance ratio is 3/4 to 1/4, and the weight coefficients are 1/4 and 3/4.

Afterward the compensation unit 10 generates an interpolation line by pixel interpolation of an original pixel inter-line by performing loop 2 (S894 to S809). In fact in loop 2, the pixel value Qj is read out of the original pixel line located immediately before the interpolation line (S805), the pixel value Qj is read out of the original pixel line located immediately after the interpolation line (S806), and a pixel value is calculated by linear interpolation using the weight coefficients (S807). Accordingly the compensation 10 compensates the vertical distortion caused by up/down movement of the imaging device.

FIG. 14A is a drawing to show vertical compensation processing to a monochrome image. The vertical shift amount from the first horizontal line to the second horizontal line is ml, the vertical shift amount from the second horizontal line and the third horizontal line is m2, and so on in this example (a shift amount to top direction is positive).

In the case of positive shift for the vertical shift amount, the image is expanded toward the bottom, the read-out total number of the original pixel lines is, therefore, greater than the number of the interpolation lines as shown in FIG. 14B. Additionally in the case of negative shift for the vertical shift amount, the image is contracted, so that the number of the generated interpolation lines is greater than the number of the original pixel lines as shown in FIG. 14C.

FIG. 15A is a drawing to show vertical compensation processing to a color image. An RGB color sensor is exemplified in this drawing. The first line and the third line include R and G, while the second line and the fourth line include B and G. In other words the lines with odd numbers include R and G, while the lines with even numbers include B and G. Accordingly the image distortion in vertical direction can be compensated by means of the above-mentioned vertical compensation processing between lines with odd numbers, or between lines with even numbers.

A method of zoom compensation based on the two lines has been described. However the zoom compensation which satisfies the condition to generate a YUV signal is allowed as a method.

As described hereinbefore, according to the imaging device of the first embodiment of the present invention, compensation for an image distortion can be realized by performing compensation of an image distortion in horizontal direction and compensation of an image distortion in vertical direction to image distortions in frame. Furthermore, the pixel position and the line position can be compensated on a pitch basis which is smaller than a pixel pitch, in both horizontal direction and vertical direction.

Additionally the compensation unit 10 may have only a line buffer with about three lines, since it is not necessary for the line buffer to have a frame memory for compensation performed in the subsequent processing. The imaging device with a smaller-sized circuit can, therefore, be configured. In fact it is not necessary for the imaging device to have a frame memory for compensation, and an image distortion in a frame, which is a defect of the conventional MOS image sensor, can be compensated.

Furthermore the number of output pixels of the sensor can be obtained without reading the entire pixels, so that the circuit for signal processing can be reduced. Accordingly the MOS image sensor can be applicable to small-sized mobile equipment such as mobile phone and PDA.

It should be noted that the pixel value performed compensation for an image distortion in the compensation unit 10 is turned to be a YUV signal in the YUV signal processing. The YUV signal is outputted to a signal processing unit, which is not shown in the drawing, a JPEG circuit and the like.

Furthermore, in the above-mentioned embodiment, the compensation unit 10 performs compensation processing to the digital pixel value outputted from the A/D converter 15, alternatively the compensation unit 10 may perform the compensation processing to the analog data at inputting side of the A/D converter 15 in the configuration.

### Second Embodiment

FIG. 16 is a block diagram to show a configuration of an imaging device of the second embodiment of the present invention.

The imaging device has the same denotations as the imaging device shown in FIG. 4 for the same components, and the same components are not described in this embodiment and the different components are described here.

A light receiving surface 42, a horizontal driving unit 43 and a vertical driving unit 44 may be the same as the conventional MOS image sensor.

The memory 47 stores a piece of frame image, and also the memory has a work area for inter-frame compensation processing and intra-frame compensation processing. The frame image outputted from the signal processing 16 has image distortions in horizontal direction and in vertical direction.

A compensation unit 48 performs inter-frame compensation processing and intra-frame compensation processing to the frame image stored in the memory 47. As intra-frame compensation processing, the compensation unit 48 performs horizontal compensation processing and vertical compensation processing as mentioned in the first embodiment to the frame image stored in the memory 47. Accordingly the compensation unit 48 performs, to the frame image stored in the memory 47, horizontal compensation processing on a pixel basis (horizontal shift readout) and horizontal compensation processing on a subpixel basis, as shown in FIG. 8, and vertical compensation processing as shown in FIG. 11. For example the compensation unit 48 determines the head position for each line based on the horizontal shift amount, and repositions the frame image stored in the memory 47 based on the determined head position. The compensation unit 48 also performs horizontal compensation on a subpixel basis in addition to horizontal compensation on a pixel basis as the repositioning. Afterward the compensation unit 48 determines an interpolating line position for each line based on the vertical shift amount, calculates the pixel signal at the compensation line position by pixel interpolation between lines to the frame image and stores in the memory 47.

Accordingly the image distortion in frame is compensated.

Additionally the compensation unit 48 performs compensation for image blur due to hand jiggling movement between frames as inter-frame compensation processing.

FIG. 17 is a drawing to show processing of intra-frame compensation and inter-frame compensation. In the drawing FIG. 17(a), an inter-frame image distortion and an intra-frame image shift due to hand jiggling movement occur at the same time. In fact a subject P30 in the image is distorted in oblique direction and also is distorted by expanded due to a movement to left-top direction, consequently the position of the frame image is shifted from the frame image f10 which is a frame image immediately before. The drawing FIG. 17(b) shows inter-frame compensation processing and intra-frame compensation processing. The compensation unit 48 performs horizontal compensation processing (on a pixel basis and on a subpixel basis) and vertical compensation processing as shown in FIG. 8, further position compensation as inter-frame compensation processing is performed. Position compensation means that the position of the frame image is compensated so as to compensate a position shift to a position shift amount in horizontal direction and a position shift amount in vertical direction in one vertical cycle. Consequently as shown in the drawing FIG. 17(c) a frame image f2, which is compensated not only an image distortion in a frame but also a position shift between frames, can be obtained.

The compensation unit 48 is not necessary to perform inter-frame compensation and intra-frame compensation individually, but to perform these compensations concurrently. In fact compensation can be performed concurrently by using the value added by the amount of a position shift in horizontal direction as a horizontal shift amount, and the value added by the amount of a position shift in vertical direction as a vertical shift amount.

It should be noted that the frame image, which has a YUV signal Y:U:V=4:4:4, Y:U:V=4:2:2 or Y:U:V=4:2:0, stored in the memory 47 can be compensated for the pixel positions on a pixel basis and on a subpixel basis, and for the line position by calculating horizontal shift amount and vertical shift amount based on a pixel on representation. Accordingly the compensation unit 47 is able to perform compensation for inter-frame and intra-frame regardless of the YUV format of the frame image stored in the memory 47. Further the frame image stored in the memory 47 can be the RGB mode.

As mentioned above, according to the imaging device of the embodiment, the pixel signals for the entire number of pixels are read out of the sensor and then stored in the memory, so that the image distortion in the frame and the hand jiggling movement between the frames can be compensated by making the readout method from the memory variable.

Moreover an image distortion and hand jiggling movement can be compensated concurrently with an ordinary MOS image sensor.

Furthermore the imaging device which realizes concurrent compensations for an image distortion and a hand jiggling movement can be configured without adding number of parts.

Furthermore the imaging device which performs image distortion compensation and hand jiggling movement compensation using an existing angle speed sensor can be realized.

It should be noted that the calculation unit 17 detects a horizontal shift amount in every single line in the above embodiment, however the calculation unit 17 does not need to perform the detection on the entire lines, and the following method may be taken alternatively.

Firstly in a case of an interlace image, the calculation unit 17 may detect a horizontal shift amount at every odd number line of the pixel portions 12 in a field of odd number, and detect a horizontal shift amount at every even number line in a field of even number.

Secondly the calculation unit 17 may detect a horizontal shift amount in every line of the predetermined number N ranged from two to the number greater than two, while the compensation unit 10 may compensate each head position of the N lines.

Thirdly the calculation unit 17 may detect a horizontal shift amount, for example in two different lines being adjacent each other every five lines for the entire line, while the compensation unit 10 may compensate the head position for the two lines, and subsequently compensate the succeeding three lines based on a prediction that the shift amount being constant.

The angle speed sensors 17 and 18 are used for detecting a horizontal shift amount and a vertical shift amount in the embodiment. However it should be noted that the configuration may be formed as detecting a motion by analyzing the frame image.

### INDUSTRIAL APPLICABILITY

The present invention is suitable for an imaging device having the MOS image sensor including a light receiving surface made up of plural of pixel units arrayed in plural lines, and is applicable to small-sized mobile equipment such as a video camera, a monitoring camera, an industrial camera and a mobile phone equipping a camera, and a Personal Digital Assistant (PDA).

1. An imaging device comprising:
a MOS image sensor including a light receiving surface made up of a plurality of pixel units arrayed in a plurality of lines;
a detection unit operable to detect a horizontal shift amount in images corresponding to two or more lines from among images on the respective lines read out for each horizontal cycle from said MOS image sensor;
a determination unit operable to determine a head position to be a head pixel in at least one line out of the plurality of lines, based on the horizontal shift amount; and
a horizontal compensation unit operable to generate a compensation image based on the determined head position.

2. The imaging device according to claim 1
wherein said detection unit is operable to detect the horizontal shift amount of the images corresponding to all adjacent two lines in the plurality of lines.

3. The imaging device according to claim 1
wherein said determination unit is operable to determine the head position at least one of the two or more lines, based on the horizontal shift amount.

4. The imaging device according to claim 2
wherein said determination unit is operable to determine the head position of the line read out subsequently, between the adjacent two lines of all adjacent two lines, based on the horizontal shift amount.

5. The imaging device according to claim 1,
wherein said detection unit includes:
an acceleration sensor operable to detect an acceleration from a movement of said imaging device; and
a calculation unit operable to calculate the horizontal shift amount based on the detected acceleration.

6. The imaging device according to claim 5,
wherein said acceleration sensor is operable to detect the acceleration for each horizontal cycle,
said calculation unit is operable to calculate the horizontal shift amount in one horizontal cycle, and
wherein said horizontal compensation unit includes
a read-out unit operable to read pixel signals, whose number is corresponding to the number of horizontal pixels, out of said MOS image sensor starting from the head position determined by said determination unit.

7. The imaging device according to claim 1
wherein said determination unit is operable to determine a head position of the line to be read out based on a head position of the line read out immediately before and the horizontal shift amount from the time of readout immediately before.

8. The imaging device according to claim 6,
wherein said determination unit is operable to determine the head position in units of a subpixel, and
said horizontal compensation unit further includes
a horizontal interpolation unit operable to compensate a pixel array in the line read out by said read-out unit to the subpixel by means of pixel interpolation.

9. The imaging device according to claim 1 further comprising:
a storage unit operable to store a frame image read out of said MOS image sensor, and
wherein said horizontal compensation unit is operable to compensate the head position to the frame image stored in said storage unit.

10. The imaging device according to claim 9,
wherein said determination unit is operable to determine the head position in units of a subpixel, and
said horizontal compensation unit is operable to compensate the frame image in units of a subpixel by means of pixel interpolation,

11. The imaging device according to claim 1,
wherein said detection unit is further operable to detect a vertical shift amount of the image, and
said imaging device further comprises
a vertical compensation unit operable to compensate a distortion expanded and contracted in vertical direction of an image captured in an image unit, based on the detected vertical shift amount.

12. The imaging device according to claim 11,
wherein said vertical compensation unit includes:
a line buffer operable to store pixel signals, whose number is corresponding to a plurality of lines read out of said MOS image sensor,
a determination unit operable to determine a compensation line position for each line, based on the vertical shift amount detected by said detection unit, and
a vertical interpolation unit operable to calculate pixel signals at the position of a compensation line by means of pixel interpolation between lines using pixel signals stored in said line buffer and pixel signals read out from said MOS image sensor.

13. The imaging device according to claim 12
wherein said vertical interpolation unit is operable to perform pixel interpolation using the pixel signals in two lines, that are the proximate two lines above and beneath the compensation line position determined by said determination unit.

14. The imaging device according to claim 13, further comprising
a storage unit operable to store the frame image read out of said MOS image sensor,
wherein said horizontal compensation unit and said vertical compensation unit are operable to compensate the head position to the frame image stored in said storage unit.

15. The imaging device according to claim 14,
wherein said detection unit is further operable to detect the vertical shift amount of the image,
said horizontal compensation unit includes:
a determination unit operable to determine the head position at each line based on the horizontal shift amount; and
a relocation unit operable to relocate the frame image stored in said storage unit based on the determined head position, and
said vertical compensation unit includes:
a determination unit operable to determine the compensation line position at each line based on the vertical shift amount; and
a vertical interpolation unit operable to calculate the pixel signal for the position of an interpolation line by means of pixel interpolation between lines to the frame image relocated by the relocation unit.

16. The imaging device according to claim 15,
wherein said detection unit is further operable to detect a position shift amount between two frames stored in said storage unit, and
said horizontal compensation unit and said vertical compensation unit are operable to compensate the position shift between frames based on the position shift amount.

17. An imaging method for an imaging device which includes a MOS image sensor having a light receiving surface made up of a plurality of pixel units arrayed in a plurality of lines, said imaging method comprising:
a detection step of detecting a horizontal shift amount in images corresponding to two or more lines from among images on the respective lines read out for each horizontal cycle from the MOS image sensor;
a determination step of determining a head position to be a head pixel in at least one line out of the plurality of lines, based on the horizontal shift amount; and
a read-out step of reading out a line based on the determined head position.

18. The imaging method according to claim 17,
wherein said detection step comprises detecting the horizontal shift amount of the images corresponding to all adjacent two lines in the plurality of lines.

19. The imaging method according to claim 17,
wherein said determination step comprises determining the head position at least one of the two or more of the lines, based on the horizontal shift amount.

20. The imaging method according to claim 18,
wherein said determination step comprises determining the head position of the line read out subsequently, between the adjacent two lines of all adjacent two lines, based on the horizontal shift amount.

21-32. (canceled)
